(19) United States
(12) Patent Application Publication
(10) Pub. No.: US 2023/0273043 A1
(43) Pub. Date: Aug. 31, 2023

(54) MAP IMAGE DISPLAY DEVICE

(71) Applicant: TOYOTA JIDOSHA KABUSHIKI KAISHA, Toyota-shi Aichi-ken (JP)

(72) Inventors: Keisuke NISHIYAMA, Kariya Aichi (JP); Yohei ANDO, Kariya Aichi (JP); Shinya HIROSAWA, Nisshin-shi Aichi-ken (JP)

(73) Assignee: TOYOTA JIDOSHA KABUSHIKI KAISHA, Toyota-shi Aichi-ken (JP)

(21) Appl. No.: 18/112,585

(22) Filed: Feb. 22, 2023

(30) Foreign Application Priority Data
Feb. 25, 2022 (JP) 2022-028156

(51) Int. Cl. G01C 21/36; G01C 21/34

(52) U.S. Cl. CPC G01C 21/3682; G01C 21/3461; G01C 21/3476; G01C 21/3614; G01C 21/367

(57) ABSTRACT

In a state where a point corresponding to a specific category located in a map image displayed on a display is set as a target, a POI icon indicating the point is superimposed and displayed on a located position of the point, and based on an operation of a user, the user selects, as a preferred brand, a brand of which an icon is to be preferentially displayed from among a plurality of brands belonging to the specific category. When there is a point corresponding to the preferred brand within a target area in the map image displayed on the display, only points corresponding to the preferred brand will be displayed with the POI icons, whereas when there is no point corresponding to the preferred brand within the target area, points that do not correspond to the preferred brand are also displayed with the POI icons.

### CROSS-REFERENCE TO RELATED APPLICATION

This application claims priority to Japanese Patent Application No. 2022-028156 filed on Feb. 25, 2022, incorporated herein by reference in its entirety.

### BACKGROUND

### 1. Technical Field

The present disclosure relates to a map image display device that displays a map image.

### 2. Description of Related Art

In recent years, many vehicles have been equipped with a navigation device that guides the vehicle so that a driver can easily arrive at a desired destination. Here, the navigation device is a device that can detect a current position of a subject vehicle using a GPS receiver or the like, obtain map data corresponding to the current position through a recording medium such as an HDD or a memory, or through a network, and display it on a liquid crystal monitor. Further, in such a navigation device, in order to guide a user to a point of interest (POI) such as facilities around the current position of the subject vehicle, it is also practiced to draw an icon indicating a point on a map image at a position at which the point corresponds to a specific category (for example, convenience store, gas station, fast food restaurant, and the like) is located. In recent years, some mobile phones, smartphones, tablet terminals, personal computers, or the like have a function similar to that of the navigation device described above.

By referring to the icons displayed on the map image, a user can grasp where the point of interest to the user is. However, particularly in an area such as an urban area where facilities are densely located, the icons described above are displayed in large numbers on the map image, and thus it is difficult for the user to find a point of interest from such a large number of icons. Therefore, for example, Japanese Unexamined Patent Application Publication No. 2008-134079 (JP 2008-134079 A) proposes a technique in which a user designates a category to be displayed so that only an icon that guides a point corresponding to the category designated by the user is displayed.

### SUMMARY

Here, among users, there are users who are interested in a specific brand among a plurality of brands (for example, chain stores) belonging to a category. Such users want to preferentially obtain information about points corresponding to the specific brand. However, in JP 2008-134079 A, although an icon for identifying a brand is displayed, a display target for the icon is not limited to a specific brand. Thus, in particular, in an area such as an urban area where facilities are densely located, many icons are displayed, and it is difficult for the user to find a point corresponding to a specific brand that interests the user. On the other hand, when only a specific brand is set as a display target for the icon, if there is no point corresponding to the specific brand near the user, there is a problem that alternative points corresponding to other brands will not be displayed.

The present disclosure provides a map image display device that can preferentially display an icon for a point corresponding to a brand in which a user is interested in a map image when displaying the map image, and can add icons of points corresponding to other brands to a display target as necessary.

A map image display device according to an aspect of the present disclosure includes a map image display unit, an icon display unit, and a selection unit. The map image display unit is configured to display a map image on a display device. The icon display unit is configured to superimpose and display an icon indicating a point corresponding to a specific category located in the map image displayed on the display device, on a located position of the point. The selection unit is configured to select, as a preferred brand, a brand of which an icon is to be preferentially displayed by a user from among a plurality of brands belonging to the specific category based on an operation by the user. The icon display unit is configured to set, as a display target for the icon, only a point corresponding to the preferred brand within a target area when there are points corresponding to the preferred brand within the target area in the map image displayed on the display device, and also set, as the display target for the icon, a point within the target area that does not correspond to the preferred brand when there is no point corresponding to the preferred brand within the target area in the map image displayed on the display device.

The “category” is, for example, a genre of facilities, and includes accommodation facilities, gas stations, shopping malls, supermarkets, shopping centers, convenience stores, theme parks, game centers, restaurants, and the like.

In addition, the “brand” is a subordinate concept of the above-described category and divides the category more finely. The “brand” includes, for example, chain stores such as franchises, store groups operated by the same owner or parent company, related group companies, a parent company (head office) and its subsidiaries (branches, sales offices), and for parking lots, the type (flat type, three-dimensional type, or the like) of parking lot, temples of the same sect, and the like.

With the aspect, when the map image is displayed, it is possible to preferentially display the icon for the point corresponding to the brand in which the user is interested in the map image. Further, if necessary, it is possible to add icons of points that correspond to other brands to the display target, and thus there is no need to perform an additional operation to search for alternative points that correspond to other brands. As a result, it is possible to improve visibility and operability of the map image.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration view illustrating an information providing system according to an embodiment;

FIG. 2 is a diagram illustrating an example of point data;

FIG. 3 is a diagram illustrating an example of data that associates points with brands they belong to;

FIG. 4 is a diagram illustrating an example of a POI icon according to the present embodiment;

FIG. 5 is a block diagram illustrating a communication terminal according to the present embodiment;

FIG. 6 is a flowchart of a map image display processing program according to the present embodiment;

FIG. 7 is a view illustrating a setting method of a display target category and a preferred brand;

FIG. 8 is a view illustrating a shape of a target area;

FIG. 9 is a view illustrating a shape of a target area;

FIG. 10 is a view illustrating a setting method of the target area;

FIG. 11 is a view illustrating a travel guidance screen displayed on a display;

FIG. 12 is a view illustrating the point to be a display target of the POI icon; and

FIG. 13 is a view illustrating the point to be a display target of the POI icon.

### DETAILED DESCRIPTION OF EMBODIMENTS

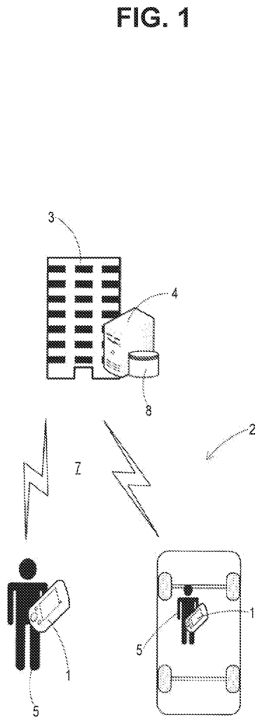

Hereinafter, a map image display device according to the present disclosure will be described in detail with reference to the drawings based on an embodiment in which a communication terminal 1 is embodied. First, a schematic configuration of an information providing system 2 including the communication terminal 1 according to the present embodiment will be described with reference to FIG. 1. FIG. 1 is a schematic configuration view illustrating the information providing system 2 according to the present embodiment.

As illustrated in FIG. 1, the information providing system 2 according to the present embodiment basically includes an information providing server 4 provided in an information providing center 3, and a communication terminal 1 owned by a user 5. Further, the information providing server 4 and the communication terminal 1 are configured to be able to transmit and receive electronic data to and from each other via a communication network 7. As the communication terminal 1, for example, a mobile phone, a smartphone, a tablet terminal, a personal computer, a navigation device that is an in-vehicle device, and the like are exemplified. Also, the user 5 may be in a state of moving by a vehicle. The user 5 may be in a state of moving by transportation other than a vehicle, or may be in a state of moving on foot.

Here, the information providing server 4 is a server device that manages transmission and reception of information in the information providing system 2. The information providing server 4 stores information to be provided to the communication terminal 1 such as map information in an information database (DB) 8. As the map information stored in the information DB 8, for example, link data related to roads (links), node data related to node points, point data related to points of facilities and the like, map display data for displaying maps, intersection data related to each intersection, search data for searching for routes, search data for searching for points, and the like are exemplified.

Here, as point data, in particular, information on points to be departure points, destinations, guidance targets, and the like in the communication terminal 1 is stored. For example, information on accommodation facilities such as hotels and inns, fueling facilities such as gas stations, commercial facilities such as shopping malls, supermarkets, shopping centers and convenience stores, entertainment facilities such as theme parks and game centers, eating and drinking facilities such as restaurants, bars, and pubs, parking facilities such as public parking lots, transportation facilities, religious facilities such as temples and churches, and public facilities such as art galleries and museums falls under this data. In addition to the various facilities described above, the points for which information is stored in the point data also include departure points, destinations, points (for example, place names, addresses, and the like) on maps that can be guidance targets and the like, in addition to the facilities. However, in the following description, a case in which the point to be the departure point, the destination, the guidance target, or the like in the communication terminal 1 is a facility will be described as an example.

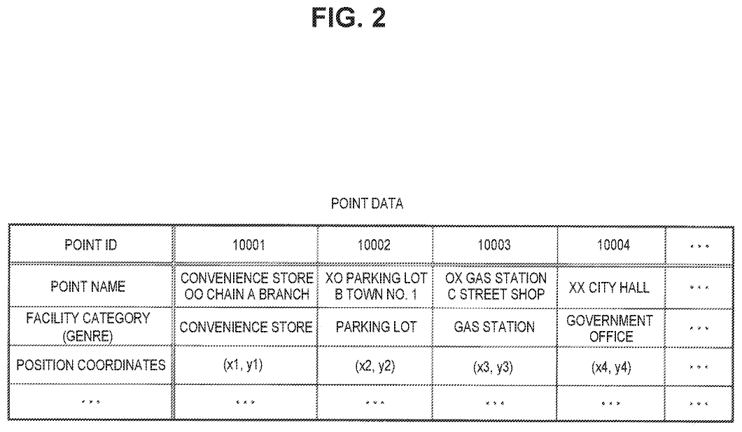

For each point, the point data includes a point ID that is an identifier of the point, a point name that indicates the name of the point, a category (only when the point is a facility) that indicates the genre (“parking lot”, “post office”, “restaurant”, and the like) of the facility, a position coordinate that indicates the position of the point, and the like. Here, FIG. 2 is a diagram illustrating an example of the point data. For example, in the example of the point data illustrated in FIG. 2, it is indicated that a “convenience store OO chain A branch (category: convenience store)” corresponding to a point ID: “10001” exists at a point of coordinates (x1, y1). In addition, it is indicated that “XO parking lot B town No. 1 (category: parking lot)” corresponding to a point ID: “10002” exists at a point of coordinates (x2, y2). Similarly, information on other points is also stored.

Further, among the facilities stored in the point data, for facilities belonging to any brand, data associating the facility with the brand to which the facility belongs and the name of the brand are also stored as the point data. For facilities (for example, public facilities, privately owned stores, and the like) that do not belong to any brand, information on the brand is not stored.

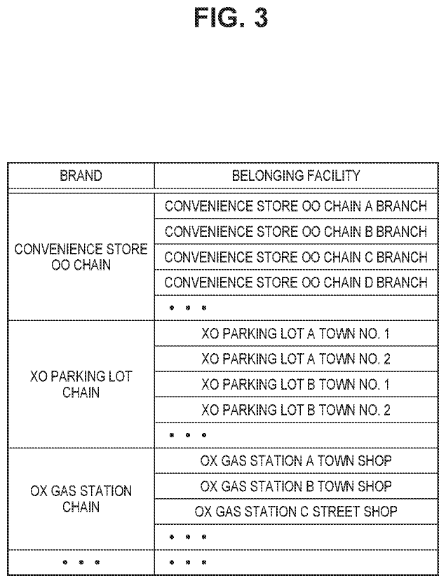

Here, as the “brand” to which the facility belongs, for example, chain stores such as franchises, store groups operated by the same owner or parent company, related group companies, parent company (head office) and its subsidiaries (branch offices, sales offices), temples of the same sect, and the like are exemplified. As for the parking lot, the type (flat type, three-dimensional type, or the like) of parking lot may be used as a brand. For example, in an example illustrated in FIG. 3, facilities that are chain stores of “convenience store OO chain” are stored in association with the brand to which they belong, facilities that are chain stores of “parking lot XO chain” are stored in association with the brand to which they belong, and facilities that are chain stores of “OX gas station chain” are stored in association with the brand to which they belong.

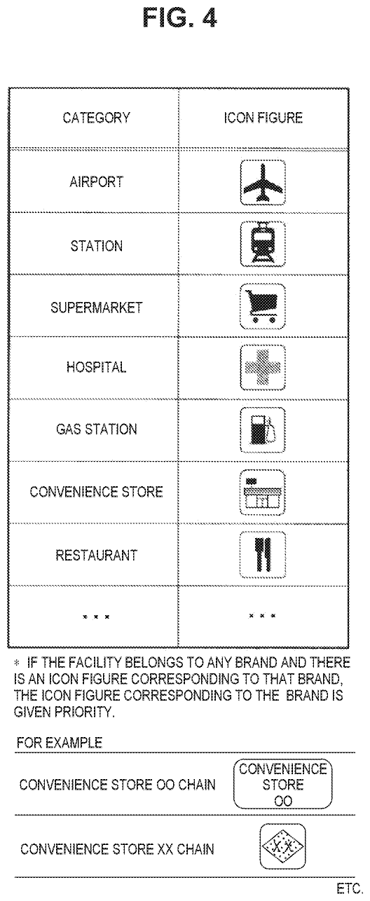

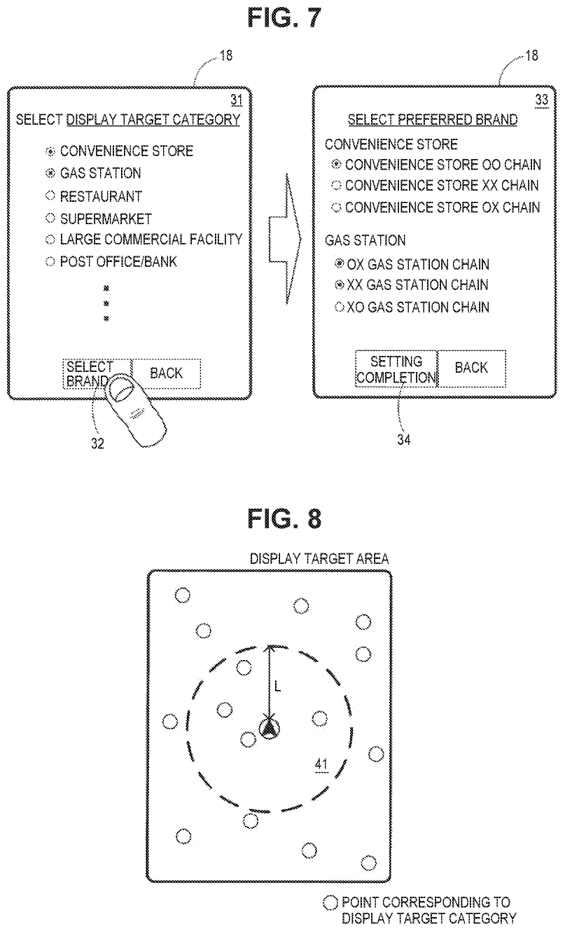

Further, as the point data, an icon (hereinafter referred to as a POI icon) displayed on the map image for specifying the content and position of the point is also stored. FIG. 4 is a diagram illustrating an example of POI icons of facilities. Here, as illustrated in FIG. 4, the POI icon is specified for each facility category, and has an external shape (including characters, symbols, designs, and the like) indicating the facility category. Then, when a map image is displayed in the communication terminal 1 based on the map information obtained by communication from the information providing server 4 as described below, if there is a facility belonging to the category to be displayed in the map image, it is displayed superimposed on the position of the facility (see FIG. 7). The POI icons do not have to be specified for all categories, and may be specified only for specific categories. Also, the POI icons may be classified for each “brand” to which the above-described facility belongs. For example, even when there are “convenience stores” of the same brand, different POI icons may be specified for a “convenience store OO chain” chain store and a “convenience store XX chain” chain store. Further, when the POI icon is specified for the brand to which the facility belongs, the POI icon specified for the brand to which the facility belongs is basically displayed preferentially over the POI icon specified for the category to which the facility belongs.

Also, in the present embodiment, when a map image for the communication terminal 1 is displayed, POI icons are not displayed for facilities that fall under all categories for which the POI icons are specified, but are displayed only for facilities that fall under categories designated by the user in advance as display targets. Further, as described below, the user can also select a brand to be a preferential display target, and when a brand to be a preferential display target is selected, the POI icons are basically displayed only for facilities corresponding to the selected brand in a specific area of the displayed map image. Details will be described below. In addition to the POI icons, icons displayed superimposed on the map image include icons indicating registered points registered by the user, icons indicating traffic information occurring on the road, and the like, but the descriptions thereof are omitted in the following description.

Further, when the information providing server 4 receives a route search request from the communication terminal 1, it is also possible to search for a route from the departure point to the destination using the map information stored in the information DB 8. Specifically, when the destination is set in the communication terminal 1, information necessary for a route search such as the departure point and destination is transmitted from the communication terminal 1 to the information providing server 4 together with the route search request. The information providing server 4 that has received the route search request performs a route search using the map information in the information providing server 4, and specifies a recommended route from the departure point to the destination. Then, the information providing server 4 transmits the specified recommended route to the communication terminal 1 from which the request is issued. Then, the communication terminal 1 sets the received recommended route as a guidance route, and performs travel guidance according to the guidance route. As a result, even when the map information in the communication terminal 1 at a time of the route search is an old version of the map information, or even when the communication terminal 1 does not have the map information itself, an appropriate guidance route can be set based on the latest version of the map information that the information providing server 4 has.

However, it is also possible for the communication terminal 1 to have the map information described above by a method such as having the communication terminal 1 download the map information in advance. When the communication terminal 1 has the map information, it is also possible for the communication terminal 1 to perform the route search process instead of the information providing server 4. Further, when the map image is displayed in the communication terminal 1, it is not necessary to obtain the map information from the information providing server 4. In some embodiments, the information providing server 4 may be omitted from the information providing system 2.

The communication terminal 1 is owned by the user 5 and is an information terminal equipped with a navigation function, such as a mobile phone, a smartphone, a tablet terminal, a personal computer, a navigation device, and the like. Especially, when the communication terminal 1 is a terminal that can execute applications such as a smartphone, an application program is installed as one of the applications that can display a map image around the user's current location or around any specified point.

In addition, the communication network 7 includes a large number of base stations located throughout the country and a communication company that manages and controls each base station, and the communication network 7 is configured by connecting base stations and communication companies to each other by wire (optical fiber, ISDN, or the like) or wirelessly. Here, the base station has a transceiver and an antenna for communicating with the communication terminal 1. Also, while the base station performs wireless communication with the communication companies, the base station becomes the end of the communication network 7 and has a role of relaying, with respect to the information providing server 4, communication of the communication terminal 1 within a range (cell) that the radio wave of the base station reaches.

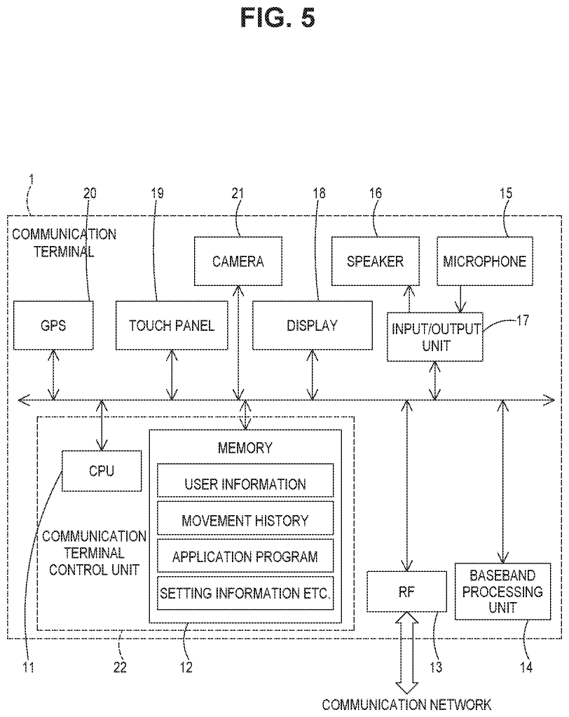

Next, a schematic configuration of the communication terminal 1 owned by the user 5 will be described with reference to FIG. 5. FIG. 5 is a block diagram schematically illustrating a control system of the communication terminal 1 according to the present embodiment. In the following description, an example in which the communication terminal 1 is a smartphone will be described.

As illustrated in FIG. 5, the communication terminal 1 is configured by connecting, to a data bus BUS, a CPU 11, a memory 12 in which user information (user ID, or the like) about the user 5 possessing the communication terminal 1, a user movement history, various setting information, and the like are stored, a transmission/reception circuit unit (RF) 13 for transmitting/receiving signals to/from the base station of the communication network 7, a baseband processing unit 14 that converts a radio frequency (RF) signal received in the transmission/reception circuit unit 13 into a baseband signal and converts the baseband signal into an RF signal, an input/output unit 17 that is an interface with a microphone 15, a speaker 16, and the like, a display 18 made up of a liquid crystal display panel or the like, a touch panel 19 arranged in front of the display 18, a GPS 20, and a camera 21.

Here, the CPU 11 incorporated in the communication terminal 1 controls the communication terminal 1 that executes various operations according to an operation program stored in the memory 12, and forms a communication terminal control unit 22 together with the memory 12. Various processing contents of the communication terminal control unit 22 are displayed on the display 18 as necessary. In addition, the communication terminal control unit 22 has various units as a processing algorithm together with a control unit of the information providing server 4. For example, a map image display unit displays the map image on the display 18. Further, for points that are located in a map image displayed on the display 18 and correspond to the specific category, an icon display unit superimposes and displays icons indicating the points on located positions of the points. A selection unit selects a brand that is selected by the user such that the icon of the brand is to be displayed preferentially from among a plurality of brands belonging to a specific category, as a preferred brand, based on the user's operation.

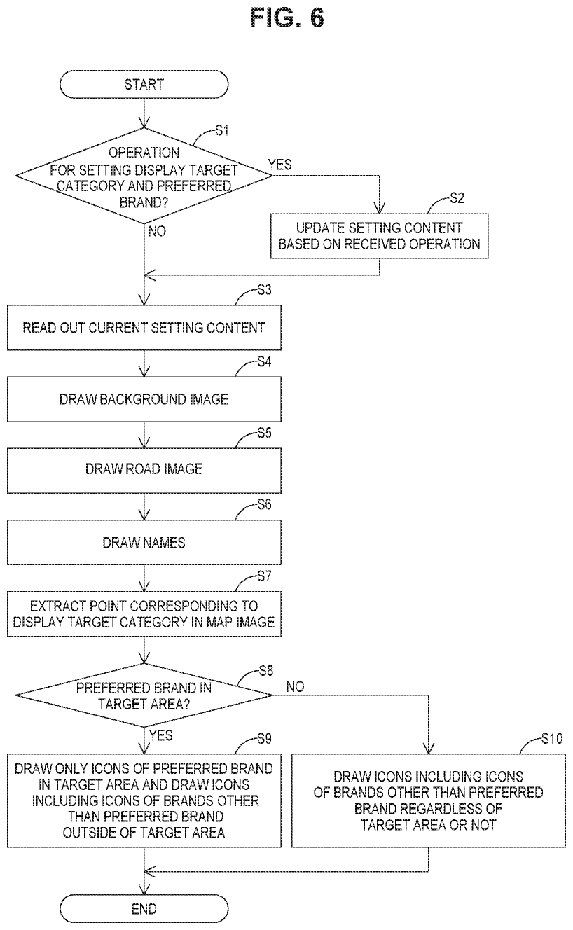

Also, the memory 12 is a storage medium in which user information (user ID, and the like) relating to the user 5 who owns the communication terminal 1, a user's web browsing history, a user's movement history, that is a history of position information detected based on the GPS 20 and other sensors, various setting information (for example, selection information of categories and brands for which POI icons are to be displayed), and the like are stored. Various application programs including a map image display processing program (FIG. 6), that will be described below, are also stored. Also, the memory 12 may be configured by a hard disk, a memory card, or the like.

The speaker 16 outputs voice guidance for driving along a guidance route (user's planned travel route) based on instructions from the communication terminal control unit 22 when a navigation function is executed, in addition to a voice output of the call.

The display 18 is arranged on one side of a housing, and a liquid crystal display, an organic light emitting display, or the like is used for the display 18. Atop screen for executing various applications installed in the communication terminal 1, screens (Internet screen, mail screen, navigation screen, and the like) related to the executed applications, and various information such as images and videos are displayed on the display 18. In particular, in the present embodiment, the display 18 is also used when displaying a map image based on the map information obtained from the information providing server 4, as will be described below.

In addition, the touch panel 19 is arranged in front of the display area of the display 18, and the touch panel 19 is operated, for example, when scrolling through map images, selecting buttons arranged in the display area, and selecting POI icons displayed on the map image. Based on a detection signal output from the touch panel 19 by operating the touch panel 19, the communication terminal control unit 22 detects “touch-on” in which the touch panel 19 is changed from a state in which the user does not touch the touch panel 19 to a state in which the touch panel 19 is touched, and “touch-off” in which the touch panel 19 is changed from a state in which the user touches the touch panel 19 to a state in which the user does not touch the touch panel 19. In addition, the communication terminal control unit 22 also detects touch coordinates that are the coordinates of the point (touch point) touched by the user, and displacement of the touch coordinates when an operation (that is, a drag operation or a flick operation) to move the touch point while being touched is received. The communication terminal control unit 22 performs control to execute various operations corresponding to the detected touch operation, touch coordinates, and the like. As an operating unit that receives a user's touch operation, the operating unit such as a tablet may be used instead of the touch panel 19. In addition to the touch panel 19, hard buttons, a mouse, and a keyboard arranged on the housing may be included as receiving units for user operations.

Also, the GPS 20 can detect the current position and current date and time of the communication terminal 1 (that is, user 5) by receiving radio waves generated by artificial satellites. Further, in addition to the GPS 20, a configuration may be adopted in which another device (for example, a gyro sensor, or the like) for detecting the current position and direction of the communication terminal 1 is provided.

The camera 21 is a small-sized image pickup device including a camera using a solid-state image pickup device such as a CCD, and is built in a back side of the communication terminal 1. By operating the touch panel 19 while the dedicated application program is activated, the user can capture an image of surroundings. The captured image captured by the camera 21 is stored in the memory 12.

Next, a map image display processing program executed by the communication terminal control unit 22 in the communication terminal 1 having the configuration described above will be described with reference to FIG. 6. FIG. 6 is a flowchart of the map image display processing program according to the present embodiment. Here, the map image display processing program is executed after a predetermined application program for displaying a map image such as a navigation application is started in the communication terminal 1, and is a program for displaying a map image on the display 18 and drawing various icons on the map image indicating the positions and contents of points to be guided to the user. The program illustrated in the flow chart in FIG. 6 below is stored in the memory 12 provided in the communication terminal 1 and executed by the CPU 11.

First, in step (hereinafter abbreviated as S) 1 in the map image display processing program, the CPU 11 determines whether an operation has been performed to set a category (hereinafter referred to as display target category) for which POI icons are to be displayed and a brand (hereinafter referred to as preferred brands) for which POI icons are preferentially displayed. Specifically, for example, when POI setting is selected from a menu screen (not illustrated) using the touch panel 19, a display target category setting screen 31 is first displayed on the display 18 as illustrated in FIG. 7. The display target category setting screen 31 displays a list of categories associated with POI icons as illustrated in FIG. 4, and by operating the touch panel 19, the user selects a category in which POI icons are displayed from the displayed list of categories, that is, a category in which the user is interested and is thinking of stopping by. The number of categories selected as display target categories is not limited to one, and a plurality of categories may be selected. At the bottom of the display target category setting screen 31, a forward button 32 for proceeding to a preferred brand setting screen is displayed, and when the user presses the forward button 32, the display screen of the display 18 switches from the display target category setting screen 31 to a preferred brand setting screen 33 as illustrated in FIG. 7. Then, the preferred brand setting screen 33 displays a list of brands belonging to the category selected as the display target category on the display target category setting screen 31 previously displayed. When a plurality of display target categories are selected, a list of brands is displayed by classifying them according to the selected display target category. Then, by operating the touch panel 19, the user selects, as a preferred brand, a brand of which the POI icon is to be preferentially displayed, that is, a brand that the user is particularly interested in and would like to stop by preferentially when it is nearby, from the list of brands displayed for each display target category. The number of brands selected as the preferred brands is not limited to one, and a plurality of brands may be selected. In some embodiments, selection of the preferred brand may be omitted, and for example, when the user does not select a preferred brand, it is also possible to assume that the user is not particular about brands and consider all brands as preferred brands. A setting completion button 34 is displayed at the bottom of the preferred brand setting screen 33, and when the user presses the setting completion button 34, setting of the display target category and the preferred brand is completed.

Then, in S1, it is determined whether an operation for setting the display target category and the preferred brand has been performed on the display target category setting screen 31 and the preferred brand setting screen 33, and when it is determined that the operation for setting the display target category and the preferred brand has been performed (S1: YES), the display target category and the preferred brand are set (updated) based on the details of the operation (S2). Information specifying the currently set display target category and preferred brand is stored in the memory 12. Next, the process proceeds to S3.

On the other hand, when it is determined in S1 that the display target category setting screen 31 and the preferred brand setting screen 33 have not been operated to set the display target category and the preferred brand (S1: NO), the process proceeds to S3 while maintaining the current settings.

In S3, the CPU 11 obtains the currently set display target category and preferred brand from the memory 12, and then draws a map image on the display 18 based on the acquired contents as follows.

The timing for drawing the map image on the display 18 by the map image display processing program is basically immediately after a predetermined application program for displaying a map image, such as a navigation application, is activated, and after that at a regular time interval (for example, every 1 sec). However, when an operation (for example, an operation to change the scale of the map image, an operation to scroll through the map image) to change the area (hereinafter referred to as the display target area) of the map image to be displayed is received on the display 18, and when an operation (for example, an operation to change the category or brand of the POI icon to be displayed as described above) to change the target object to be displayed is received on the display 18, drawing the map image is also executed at the timing when the operation is received.

First, in S4, the CPU 11 first draws a background image as a map image on the display 18 based on the map information obtained from the information providing server 4. Here, the display target area to which the background image is to be drawn in S4 is, for example, the area around the current position of the vehicle. Also, the size of the display target area differs depending on the display scale of the map image set in the communication terminal 1. The smaller the scale, the wider the area. Further, the display target area is appropriately changed according to subsequent user operations (for example, map image scroll through operation, map image scale change operation) or movement of the current position of the vehicle.

Next, in S5, the CPU 11 draws a road image in the display target area according to the background image drawn in S4 based on the map information obtained from the information providing server 4. When there is traffic information (for example, congestion information, road closure information) on the road, an image illustrating the traffic information may also be drawn.

Next, in S6, based on the map information obtained from the information providing server 4, the CPU 11 draws character strings indicating various names of areas and points in the display target area according to the background image drawn in S4 and the road image drawn in S5. Here, the character strings to be drawn include, for example, place names, facility names, river names, road names, and the like. A map image of the display target area is drawn on the display 18 by S4 to S6.

Then, in S7, the CPU 11 targets the display target area where the map image is displayed on the display 18, and extracts the points (regardless of brand) corresponding to the current display target category read out in S3. In addition, the point data in the map information obtained from the information providing server 4 stores the category and position information for each point as illustrated in FIG. 2, and points corresponding to the display target category are extracted based on the point data.

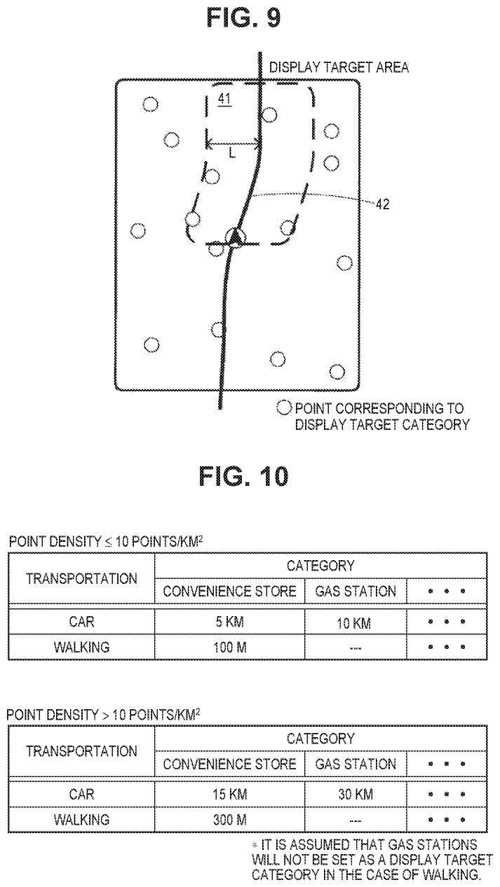

Subsequently, in S8, the CPU 11 selects, from among the points corresponding to the display target category in the display target area extracted in S7, particularly the points within the target area, and then the CPU 11 further determines whether there are at least one or more points corresponding to the preferred brand read in S3 in the selected points. Here, the target area 41 is assumed to be an area within a predetermined distance L from the user's current position, as illustrated in FIG. 8. However, the shape of the target area 41 is not necessarily limited to a circular shape, and may be a rectangular shape. Also, instead of the user's current position, the area within the predetermined distance L from the center point of the screen or any point specified by the user may be used. Further, when a guidance route (planned travel route) to the destination is set in the communication terminal 1, as illustrated in FIG. 9, the target area 41 may be an area within the predetermined distance L based on a guidance route 42.

Here, the predetermined distance L may be a fixed distance (for example, 1 km), but it is desirable to set it as appropriate based on a display mode of the map image of the communication terminal 1 and the user's movement status. Specifically, it is desirable to set the predetermined distance L based on at least one of the transportation of the user, the display scale for displaying the map image on the display 18, the type of a display target category, and the density of surrounding points corresponding to the display target category.

For example, FIG. 10 is a diagram illustrating an example of a method for setting the predetermined distance L. For example, when the case where the display target category is a convenience store is described, first of all, if the density of surrounding points corresponding to the display target category (that is, convenience store) is 10 points/km² or less, that is, in a facility-depopulated area such as a suburb, L=5 km when the user's transportation is by car, and L=100 m when the user is on foot. On the other hand, when the density of surrounding points corresponding to the display target category (that is, convenience stores) is higher than 10 points/km², that is, in a facility-dense area such as an urban area, L=15 km when the user's transportation is by car, and L=300 m when the user is on foot. Next, to describe the case where the display target category is gas stations, when the density of surrounding points corresponding to the display target category (that is, gas station) is 10 points/km′ or less, that is, in a facility-depopulated area such as a suburb, L=km when the user's transportation is by car. On the other hand, when the density of surrounding points corresponding to the display target category (that is, gas station) is higher than 10 points/km′, that is, in a facility-dense area such as an urban area, L=30 km when the user's transportation is by car.

Here, when the user's transportation is compared, for the same category, the faster the movement speed of the user's transportation is, the larger the target area is set. That is, when the user's transportation is a fast car, the user's range of action expands, and even when the preferred brand is far away, it is expected that the user will preferentially stop by the favorite brand. Therefore, a larger target area is set (that is, the area where only the preferred brand is displayed is widened). On the other hand, when the user's transportation is slow walking, the user's range of action is narrowed, and when the favorite brand is far away, it is expected that the user will stop by other brands that are closer than the favorite brand. Therefore, a smaller target area is set (that is, the area where only the preferred brand is displayed is reduced). The user's transportation can be input by the user, but can also be estimated from the movement speed of the user.

Also, when the point densities are compared, for the same category, the higher the density of surrounding points, the larger the target area is set. That is, in a facility-dense area such as an urban area, the number of points corresponding to the display target category increases, and the number of POI icons to be displayed also increases. Therefore, a larger target area is set (that is, the area where only the preferred brand is displayed is widened to improve visibility). On the other hand, in a facility-depopulated area such as a suburb, the number of points corresponding to the display target category is reduced, and the number of POI icons to be displayed is also reduced. Therefore, a smaller target area is set (that is, the area where only the preferred brand is displayed is reduced to display more icons).

The setting method for the predetermined distance L is not limited to the method disclosed in FIG. 10, and for example, the predetermined distance L may be set with a display scale for displaying the map image on the display 18. For example, when the display scale is reduced, the number of POI icons to be displayed will also increase, so it is possible to set a larger target area (that is, widen the area where only the preferred brand is displayed to improve visibility).

Then, when it is determined that there is at least one or more points corresponding to the preferred brand read in S3 in the target area (S8: YES), the process proceeds to S9. On the other hand, when it is determined that there is no point corresponding to the preferred brand read in S3 in the target area (S8: NO), the process proceeds to S10. In S8, it is determined whether there are at least one or more points corresponding to the preferred brand in the target area, but it may be determined whether there is a predetermined number or more (for example, three or more).

In S9, the CPU 11 sets only points corresponding to the preferred brand as icon display targets for the points corresponding to the display target category in the target area, and for the outside of the target area, the CPU 11 sets, as icon display targets, points corresponding to all display target categories regardless of whether they are preferred brands or not. Then, the CPU 11 draws POI icons according to the result. In addition to the POI icons, an icon indicating a registered point registered by the user, an icon indicating traffic information occurring on the road, and the like are drawn as necessary. As a result, the display 18 displays a travel guidance screen 50 that displays the map image of the user's surroundings together with the point information in the map image.

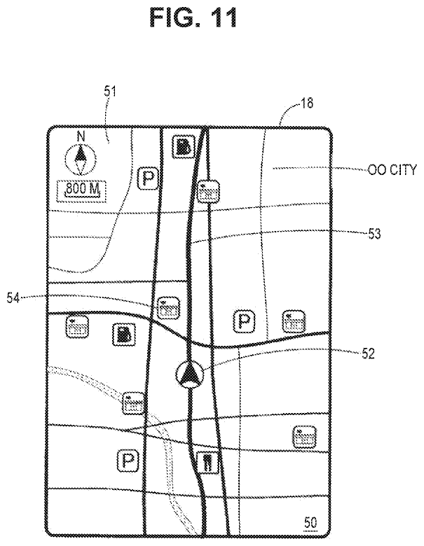

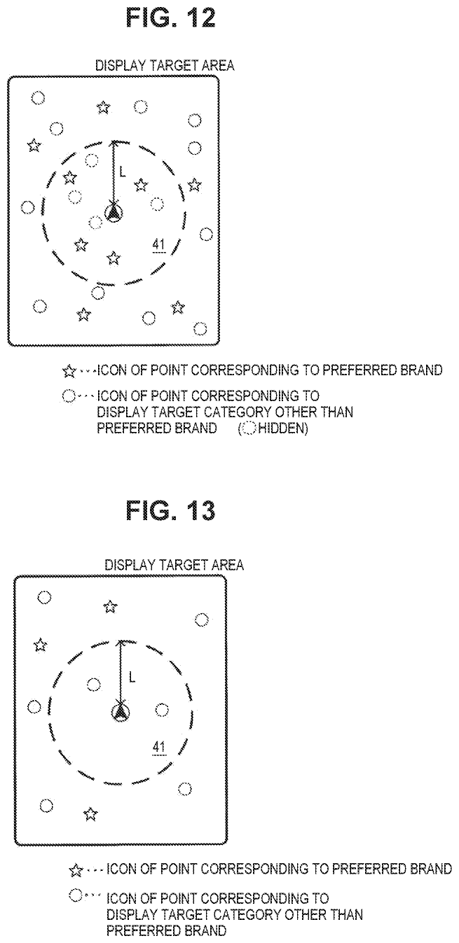

Here, FIG. 11 is a view illustrating an example of the travel guidance screen 50 displayed on the display 18. As illustrated in FIG. 11, a map image 51 around the current position of the vehicle, a subject vehicle position mark 52 indicating the current position of the vehicle matched on the map, a route image 53 indicating the shape of the guidance route (displayed only when the guidance route is set) set for the communication terminal 1 are displayed on the travel guidance screen 50. Various icons are drawn on the map image 51, such as POI icons 54 indicating the positions and genres of facilities, and registered point icons indicating registered points registered by the user. As illustrated in FIG. 12, the POI icon 54 drawn on the map image is basically within the display target area of the map image 51, and the POI icon indicating the facility of the display target category (for example, parking lots, gas stations, convenience stores, restaurants) set as the display target for the POI icon is displayed. However, not all corresponding POI icons are displayed, but only POI icons corresponding to the preferred brand within the target area 41 are to be displayed.

On the other hand, in S10, also regarding to the target area 41, the CPU 11 sets the points corresponding to all the display target categories as icon display targets regardless of whether they are preferred brands or not, and draws the POI icons according to the result. Therefore, as illustrated in FIG. 13, the POI icon 54 drawn on the map image displays all POI icons that indicate facilities in the display target category (for example, parking lots, gas stations, convenience stores, restaurants) that are within the display target area of the map image 51 and that are set as display targets for the POI icons.

As a result, by referring to the travel guidance screen 50 displayed on the display 18, the user can grasp the shape of roads and facilities around the user, the route to the destination, and the like. In addition, when there is a point corresponding to the preferred brand set in advance within the target area 41 particularly close to the user, as illustrated in FIG. 12, only the POI icons 54 of the points corresponding to the preferred brand are displayed, so the number of POI icons 54 to be displayed can be limited. Therefore, by using the POI icons 54, it is possible to appropriately give guidance on candidate points where the user will stop by while ensuring the visibility. In the example illustrated in FIG. 12, the target area 41 is narrower than the display target area of the map image, but the target area 41 may be larger than the display target area depending on the scale of the map image. In this case, only the POI icon 54 of the point corresponding to the preferred brand is displayed on the entire screen of the display 18. On the other hand, when there is no point corresponding to the preferred brand in the target area 41, as illustrated in FIG. 13, the POI icon 54 corresponding to the point other than the preferred brand is also displayed, so that it is possible to appropriately give guidance on the point of another brand as an alternative by using the POI icon 54.

After the travel guidance screen 50 illustrated in FIG. 11 is displayed, when an operation to select any of the POI icons 54 drawn on the map image 51 is accepted, for example, the CPU 11 sets a point corresponding to the POI icon 54 selected by the user as a new destination or waypoint, and provides more detailed information about the point.

As described in detail above, in the communication terminal 1 according to the present embodiment and a computer program executed by the communication terminal 1, in a state where a point corresponding to the display target category located in the map image 51 displayed on the display 18 is set as a target, the POI icon 54 indicating the point is superimposed and displayed on a located position of the point (S9, S10), and based on the user's operation, the user selects, as a preferred brand, a brand of which the icon is to be preferentially displayed from among a plurality of brands belonging to the display target category (S2). Further, when there is a point corresponding to the preferred brand within the target area 41 in the map image displayed on the display 18, only the points corresponding to the preferred brand within the target area 41 will be displayed with the POI icon 54, whereas when there is no point corresponding to the preferred brand within the target area 41, the points within the target area 41 that do not correspond to the preferred brand are also displayed with the POI icon 54. As a result, when displaying the map image, it is possible to preferentially display the icon for the point corresponding to the brand in which the user is interested within the map image. Also, if necessary, it is possible to add icons of points that correspond to other brands to the display target, and there is no need to perform an additional operation to search for alternative points that correspond to other brands. As a result, it is possible to improve the visibility and operability of the map image. In addition, since the target area is an area around the user's current position or an area around the planned travel route to the user's destination, when displaying the map image, it is possible to preferentially display the icons of the points corresponding to the brands that the user is interested in, particularly around the user's current position and around the planned travel route. As a result, it is possible to appropriately provide information on candidate points for the user to stop by using icons. Also, the shape of the target area is set based on at least one or more of the transportation of the user, the display scale for displaying the map image on the display 18, the type of display target category, and the density of surrounding points corresponding to the display target category. Therefore, it is possible to appropriately set the range in which the icon of the point corresponding to the brand in which the user is interested is preferentially displayed in consideration of the display mode of the map image and the user's movement status. Also, the faster the movement speed of the user's transportation is, the larger the target area is set, so it is possible to estimate the range in which the user can stop by from the transportation, and based on the result, appropriately set the range in which the icon of the point corresponding to the brand that the user is interested in is preferentially displayed.

The present disclosure is not limited to the embodiment described above, and of course various improvements and modifications are possible without departing from the gist of the present disclosure. For example, in the present embodiment, only whether each brand belonging to the display target category is set as the preferred brand is set in the preferred brand setting (S2). However, a plurality of preferred brands may be selected, and the order of priority may be set within the selected preferred brands. Further, in S8, it is also possible for the CPU 11 to determine whether there is a point corresponding to the preferred brand within the target area in the map image displayed on the display 18 in order of priority and set, as the display target, the POI icon 54 only at the point corresponding to the highest-priority preferred brand determined to be within the target area.

Also, in the present embodiment, when there is a point corresponding to the preferred brand within the target area, the POI icon corresponding to the point other than the preferred brand in the target area will be completely hidden, but it may be displayed by changing the display mode. For example, it is possible to display the POI icons of other brands in a semi-transmissive state or display them in a reduced size.

In addition, the present disclosure can be applied as a map image display device to various devices having a map image display function other than smartphones. For example, it can be applied to a mobile phone, a tablet terminal, a personal computer, a navigation device that is an in-vehicle device, and the like. Further, the data of the map image to be displayed may be stored in the communication terminal in advance, or may be obtained from an external server each time the data is displayed.

The present disclosure can also be applied to a system composed of a server and a communication terminal. In this case, each step of the above-described map image display processing program (FIG. 5) may be executed by either the server or the communication terminal.

What is claimed is:

1. A map image display device, comprising:
a map image display unit configured to display a map image on a display device;
an icon display unit configured to superimpose and display an icon indicating a point corresponding to a specific category located in the map image displayed on the display device, on a located position of the point; and
a selection unit configured to select, as a preferred brand, a brand of which an icon is to be preferentially displayed by a user from among a plurality of brands belonging to the specific category based on an operation by the user,
wherein the icon display unit is configured to:
set, as a display target for the icon, only a point corresponding to the preferred brand within a target area when there are points corresponding to the preferred brand within the target area in the map image displayed on the display device; and
also set, as the display target for the icon, a point within the target area that does not correspond to the preferred brand when there is no point corresponding to the preferred brand within the target area in the map image displayed on the display device.

2. The map image display device according to claim 1, wherein the target area is an area around a current position of the user or an area around a planned travel route to a destination of the user.

3. The map image display device according to claim 1, further comprising:
a shape setting unit configured to set a shape of the target area,
wherein the shape setting unit is configured to set the shape of the target area based on at least one or more of transportation of a user, a display scale that displays a map image on the display device, a type of a specific category, and a density of surrounding points corresponding to the specific category.

4. The map image display device according to claim 3, wherein the shape setting unit is configured to set the target area larger as a movement speed of the transportation of the user increases.

5. The map image display device according to claim 1,
wherein the selection unit is configured to select a plurality of the preferred brands based on an operation of a user and set a priority order in the selected preferred brands, and
wherein the icon display unit is configured to:
determine whether there is a point corresponding to the preferred brand within the target area in the map image displayed on the display device in order of priority; and
set, as the display target for the icon, only a point corresponding to the preferred brand with the highest priority, that is determined to be within the target area.
